(19) United States
(12) Patent Application Publication
(10) Pub. No.: US 2004/0137847 A1
(43) Pub. Date: Jul. 15, 2004

(54) Remote-controlled toy

(75) Inventors: Masanori Mizunuma, Inzai-shi (JP); Yoshio Suimon, Tokyo (JP); Hirofumi Mano, Kawasaki-shi (JP); Tadashi Orihara, Soka-shi (JP)

Correspondence Address: STAAS & HALSEY LLP, SUITE 700, 1201 NEW YORK AVENUE, N.W., WASHINGTON, DC, 20005, US

(73) Assignee: TOMY COMPANY, LTD, Tokyo (JP)

(21) Appl. No.: 10/685,572

(22) Filed: Oct. 16, 2003

(30) Foreign Application Priority Data
Oct. 16, 2002 (JP) 2002-301720

(51) Int. Cl. H04B 7/00

(52) U.S. Cl. 455/66.1

(57) ABSTRACT

A transmission timing control section latches operational data received from an operating section in timing corresponding to a channel set in a channel setting section, compares the latched operational data and last operational data stored in a temporarily storage section and judges whether or not the latched operational data is identical with the last operational data. In case of the judgment for those to be identical with each other, no transmission instructing signal is outputted, and the transmission of the communication data is stopped in that timing. In case of the judgment for those not to be identical with each other, a transmission instructing signal is outputted from the transmission timing control section to a transmitting section to transmit the communication data in that timing.

### BACKGROUND OF THE INVENTION

1. Field of the Invention

The invention relates to a remote-controlled toy having both a transmitter for transmitting communication data including identification data and operational data and a receiver for receiving the communication data transmitted from the transmitter and performing a controlled operation based on the operational data of the received communication data of which the identification data is identical with that stored in advance in a storage.

2. Description of Related Art

A plurality of remote-controlled toys respectively composed of a transmitter and a receiver are prepared, and various techniques in which each transmitter accurately and remotely controls the corresponding receiver have been developed. For example, there is a well-known technique in which both the transmitter and the receiver of each remote-controlled toy store the same identification data (ID), the communication data including the ID is transmitted from each transmitter and the communication data of each remote-controlled toy is distinguished from those of the other remote-controlled toys. Also, there is another well-known technique in which the communication is performed in each remote-controlled toy at a communication frequency (frequency of carrier wave) differing from those of the other remote-controlled toys.

However, when the communication is performed in each remote-controlled toy at the communication frequency differing from those of the other remote-controlled toys, it is required that each remote-controlled toy can perform the communication at any one of a plurality of communication frequencies and a user plays by switching over from one communication frequency to another one. Also, a frequency band usable for the remote-controlled toys is limited. To perform the communication in each remote-controlled toy at the communication frequency differing from those of the other remote-controlled toys, a wide frequency band is required. Therefore, it is desired to perform the communication in the remote-controlled toys at the same communication frequency.

To perform the accurate and remote control of the toys at the same communication frequency, there is a well-known technique in which a plurality of transmission cycles (transmission intervals) denoting a plurality of different cycles of the data transmission and respectively expressed by a combination of a transmission time period and a non-transmission time period (weight) are prepared in advance and data is transmitted in one of the transmission cycles. For example, this technique is disclosed in the Japanese Patent Gazette No. 2625617 and the Published Unexamined Japanese Patent Application No. 2002-78044.

However, even though the transmission cycle of data in each remote-controlled toy differs from those in the other remote-controlled toys, the data in one toy is transmitted simultaneously with that in another toy at a time corresponding to a common multiple of the transmission cycles of the toys. Therefore, a cross talk caused by a collision (superposition) of the communication data occurs, and there is a probability that the receiver malfunctions.

Also, to avoid the collision of the communication data, it is preferred that the transmission cycle is lengthened. However, in this case, responsive performance of the toy for the remote control becomes worse. Therefore, a technique satisfying both the length of the transmission cycle and the responsive performance of the remote-controlled toy denoting two contrary conditions is desired.

### SUMMARY OF THE INVENTION

In order to solve the above problem, an object of the present invention is to provide a remote-controlled toy of which a receiver is operated as reliably as possible even though data is transmitted to the receiver in a changed transmission cycle and which performs the remote control more accurately.

Another object of the present invention is to provide a remote-controlled toy which satisfies two contrary conditions of both the length of the transmission cycle and the responsive performance.

In order to accomplish the above-mentioned object, in accordance with the first aspect of the present invention, a remote-controlled toy (for example, remote-controlled toy according to first embodiment) comprises:

a transmitter (for example, remote controller 100 of FIG. 2), having an operating section (for example, operating section 112 of FIG. 2), for transmitting communication data including both identification data (for example, ID 142 of FIG. 2) and operational data received from the operating section; and

a receiver (for example, running toy 200 of FIG. 6) for receiving the communication data transmitted from the transmitter, setting the communication data as communication data for this receiver when the identification data included in the received communication data is identical with identification data (for example, ID 242 of FIG. 6) stored in a storage section (for example, storage section 240 of FIG. 6) in advance, and performing a control operation based on the operational data of the communication data for this receiver,

the transmitter further comprises:

a setting section (for example, channel setting section 118 of FIG. 2) for setting a transmission cycle of the communication data;

a judging section (for example, transmission timing control section 124 of FIG. 2) for judging whether or not the operational data inputted to the operating section is changed; and

a transmission control section (for example, transmission timing control section 124 of FIG. 2; Steps S106 to S108 of FIG. 7) for transmitting no communication data when the judging section judges that the operational data inputted to the operating section is not changed, and transmitting the communication data in the transmission cycle set by the setting section when the judging section judges that the operational data inputted to the operating section is changed, and

the receiver continues performing the current control operation until new communication data for this receiver is received.

In the above configuration, even in the timing (transmission cycle) of the transmission of the communication data, when the operation of the user is not changed, the transmitter does not transmit the communication data. Therefore, the occurrence frequency of collisions (superposition) in the transmission of the communication data can be reduced, and a malfunction of the transmitter due to cross talk can be prevented within the range of possibility. Also, because the receiver continues performing the current control operation until new communication data for this receiver is received, a problem that the receiver cannot receive the communication data for this receiver (in other words, the transmitter does not transmit the communication data for this receiver) can be prevented.

Preferably, the transmission control section stops transmitting the communication data, when the judging section judges that the operational data inputted to the operating section is not changed, after the elapsing of a prescribed time period from a last judgment for last operational data inputted to the operating section to be changed or after the transmission of the communication data prescribed number times from the last judgment for the last operational data inputted to the operating section to be changed.

In the above configuration, even when the judging section judges that the operational data is not changed, the transmitter transmits the communication data for the prescribed time period or prescribed number times. Therefore, even when the receiver does not receive, due to the collision in communication, the communication data just before the judgment not to be changed (or at the time of the last judgment to be changed), because the communication data is transmitted repeatedly, the remote control for the receiver can be more reliably embodied.

Preferably, the setting section has a switch for selecting a transmission cycle from a plurality of transmission cycles and sets the transmission cycle selected by the switch as the transmission cycle of the communication data.

In the above configuration, the transmission cycle can be set more simply by changing the transmission cycle by using the switch.

In accordance with the second aspect of the present invention, a remote-controlled toy (for example, remote-controlled toy according to second embodiment) comprises:

a transmitter (for example, remote controller 100 of FIG. 2), having an operating section (for example, operating section 112 of FIG. 2), for transmitting communication data including both identification data (for example, ID 142 of FIG. 2) and operational data received from the operating section; and

a receiver (for example, running toy 200 of FIG. 6) for receiving the communication data transmitted from the transmitter, setting the communication data as communication data for this receiver when the identification data included in the received communication data is identical with identification data (for example, ID 242 of FIG. 6) stored in a storage section (for example, storage section 240 of FIG. 6) in advance, and performing a control operation based on the operational data of the communication data for this receiver,

the transmitter further comprises:

a selecting section (for example, channel setting section 118 of FIG. 2) for selecting a channel from a plurality of channels, at least two transmission cycles of a long cycle and a short cycle being preset for each channel;

a judging section (for example, transmission timing control section 124 of FIG. 2) for judging whether or not the operational data inputted to the operating section is changed; and

a transmission control section (for example, transmission timing control section 124 of FIG. 2; Steps S306 to S318 of FIG. 10) for changing the transmission cycles, which are set in the channel selected by the selecting section, according to a judgment result of the judging section, and controlling the communication data to be transmitted in the changed transmission cycle, and

the receiver continues performing the current control operation until new communication data for this receiver is received.

In the above configuration, because the transmitter can change the transmission cycle of the communication data according to the existence or no existence of the operation change, the remote-controlled toy satisfying two contrary conditions of both the length of the transmission cycle and the responsive performance within the range of possibility can be obtained. In detail, for example, in the same manner as in the following invention, when the judging section judges not to be changed, the transmission control section changes the transmission cycle to the long cycle. In contrast, when the judging section judges to be changed, the transmission control section changes the transmission cycle to the short cycle.

Preferably, the transmission control section changes the transmission cycle to the long cycle, when the judging section judges that the operational data inputted to the operating section is not changed, and changes the transmission cycle to the short cycle when the judging section judges that the operational data inputted to the operating section is changed.

In the above configuration, because the transmission at the short cycle is performed in case of the operation change, the responsive performance for the remote control can be improved. In contrast, because the transmission cycle is changed to the long cycle in case of non-operation change, the collision in the communication can be prevented within the range of possibility.

Preferably, the transmission control section changes the transmission cycle to the short cycle, when the judging section judges that the operational data inputted to the operating section is changed, and changes the transmission cycle to the long cycle, when the judging section judges for the operational data inputted to the operating section not to be changed after a last judgment to be changed, after the elapsing of a prescribed time period from the last judgment or after the transmission of the communication data prescribed number times from the last judgment.

In the above configuration, even when the judging section judges not to be changed, the transmitter transmits the communication data at the short cycle during the prescribed time period or prescribed number times. Therefore, even when the receiver does not receive, due to the collision in communication, the communication data just before the judgment not to be changed (or at the time of the last judgment to be changed), because the communication data is transmitted repeatedly, the remote control for the receiver can be more reliably embodied.

Preferably, a communication frequency in the communication between the transmitter and the receiver is constant.

In the above-described remote-controlled toy, the transmission cycle of the communication data can be set. Therefore, when users play with a plurality of remote-controlled toys, it is preferred that the transmission cycles of the remote-controlled toys are set to differ from each other. Accordingly, the communication frequency in the communication between the transmitter and the receiver can be constant.

### BRIEF DESCRIPTION OF THE DRAWINGS

The present invention will become more fully understood from the detailed description given hereinbelow and the accompanying drawing which are given by way of illustration only, and thus are not intended as a definition of the limits of the present invention, and wherein;

FIG. 1A is a view showing outward appearance of a remote-controlled toy, and FIG. 1B is a view showing outward appearance of another remote-controlled toy;

FIG. 2 is a functional block diagram of the remote controller according to a first embodiment;

FIG. 3 is an explanatory view of transmission cycle according to the first embodiment;

FIG. 4 shows a data format of communication data according to the first embodiment;

FIG. 5A is a view showing definition of “high” and “low” in amplitude-shift keying of a transmitting section according to the first embodiment, and FIG. 5B is a view showing an example of a modulated output according to the first embodiment;

FIG. 6 is a functional block diagram of the running toy according to the first embodiment;

FIG. 7 is a flow chart schematically showing transmission of communication data of the remote controller according to the first embodiment;

FIG. 8 is a flow chart schematically showing reception of communication data of the running toy according to the first embodiment;

FIG. 9A is a view showing an example of instantaneous stop, and FIG. 9B is a view showing an example of stop delay; and

FIG. 10 is a flow chart schematically showing transmission of communication data of the remote controller according to a second embodiment.

### PREFERRED EMBODIMENTS OF THE INVENTION

Hereinafter, embodiments of the present invention will be explained with reference to the drawings. In the embodiments, a remote controller is used as a transmitter, and a running toy imitating a vehicle is used as a receiver. The present invention is applied to a remote-controlled toy having the remote controller and the running toy. However, the modification to which the present invention can be applied is not limited this remote-controlled toy.

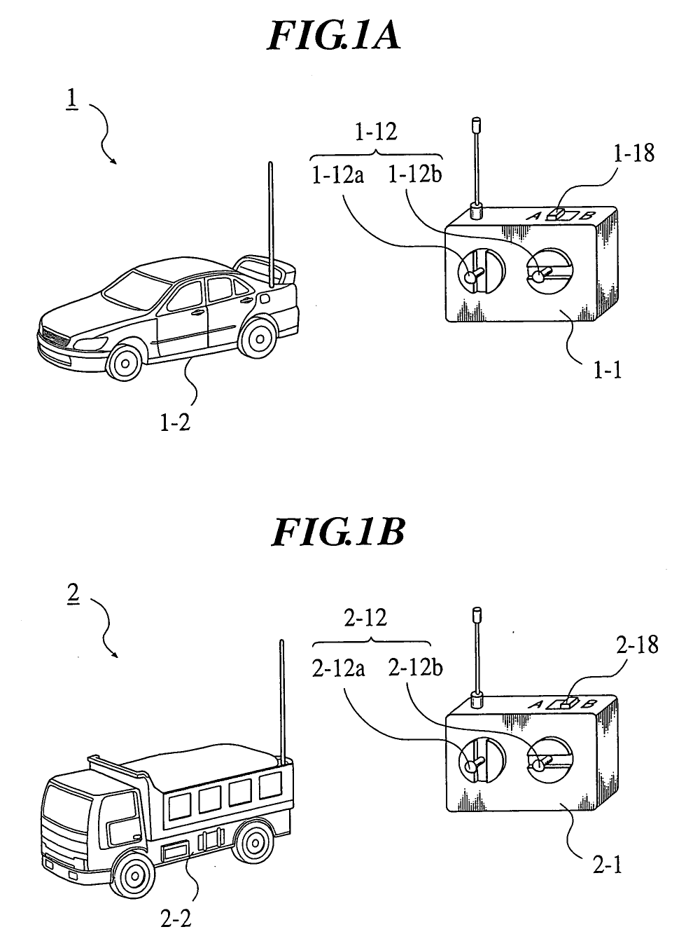

FIG. 1A is a view showing an outward appearance of a remote-controlled toy 1, and FIG. 1B is a view showing an outward appearance of another remote-controlled toy 2. The remote-controlled toy 1 comprises a remote controller 1-1 and a running toy 1-2. The remote-controlled toy 2 comprises a remote controller 2-1 and a running toy 2-2. The remote-controlled toys 1 and 2 perform the communication at the frequency of 27 MHz together. In FIGS. 1A and 1B, the remote controller 1-1 is set to a channel “A” by a switch 1-18, and the remote controller 2-1 is set to a channel “B” by a switch 2-18. Therefore, the communication frequency (frequency of carrier wave) of the remote-controlled toy 1 is the same as that of the remote-controlled toy 2, but a transmission timing of the remote-controlled toy 1 differs from that of the remote-controlled toy 2.

Each of users inputs a running speed (corresponding to an acceleration opening) including forward/backward by using a control stick 1-12a or 2-12a, and inputs a turn angle (corresponding to a steering angle) in the range of right and left directions by using a control stick 1-12b or 2-12b. Therefore, the users remotely operate the running toys 1-2 and 2-2. Communication data includes both operational data input by the user using the control stick 1-12 or 2-12 and identification data stored in the remote-controller 1-1 or 2-1.

Hereinafter, two embodiments relating to the remote controlled toys 1 and 2 will be explained.

First Embodiment:

First embodiment will be first explained.

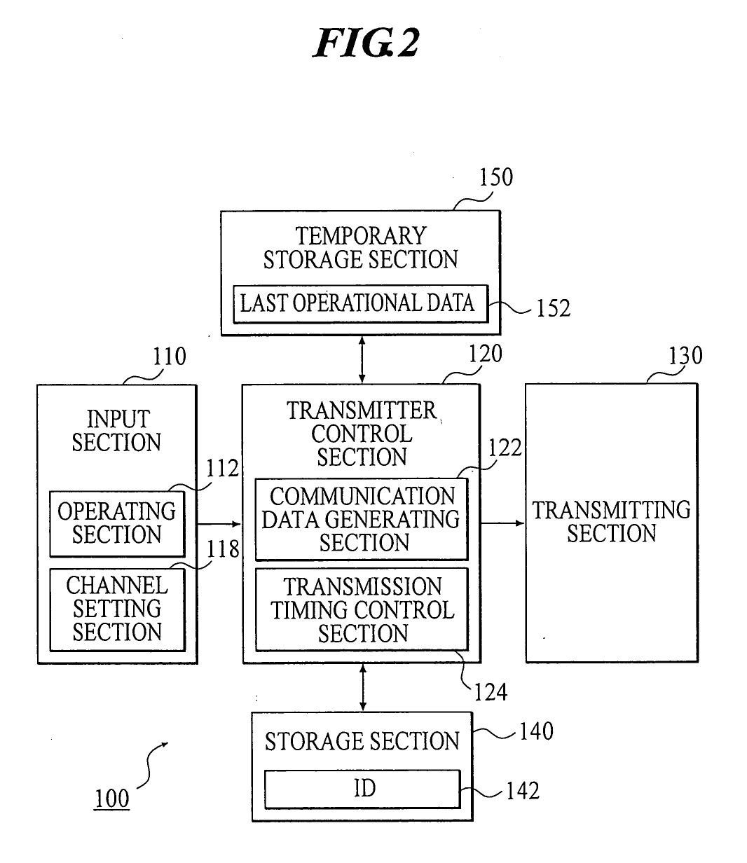

The functional configuration of the remote-controlled toys 1 and 2 according to the first embodiment will be explained. FIG. 2 is a functional block diagram of each remote controller 1-1 and 1-2 (hereinafter, named remote controller 100 comprehensively) according to the first embodiment. The remote controller 100 comprises an input section 110, a transmitter control section 120, a transmitting section 130, a storage section 140 and a temporarily storage section 150.

The input section 110 comprises an operating section 112 corresponding to the control stick 1-12 or 2-12 and a channel setting section 118 corresponding to the switch 1-18 or 2-18. The operating section 112 detects an amount of operation input by the user, performs the analog-to-digital (A/D) conversion or the like for the inputted operation and outputs operational data to the transmitter control section 120. The channel setting section 118 outputs a signal indicating a transmission cycle channel set by the user. In the first embodiment, the channel A denotes a fixed transmission cycle (transmission interval) of 187 ms, and the channel B denotes a fixed transmission cycle of 289 ms.

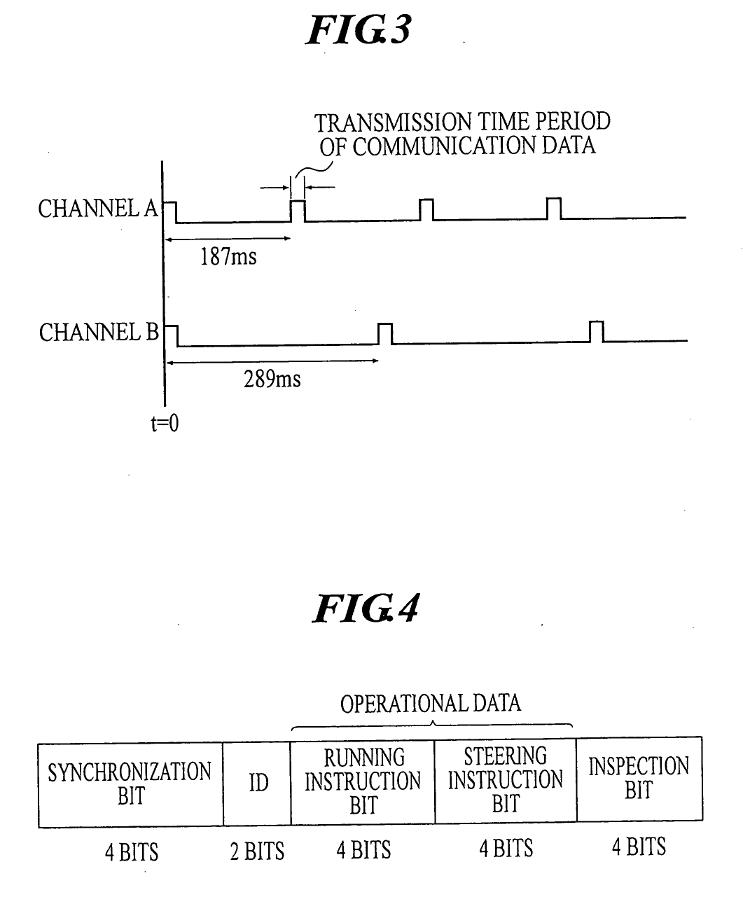

Here, the transmission cycle will be explained. FIG. 3 is an explanatory view of the transmission cycle. The lateral axis indicates a time axis. In FIG. 3, at a time of t=0, the communication data at the channel A is transmitted simultaneously with that at the channel B. Thereafter, the communication data at the channel A is transmitted every 187 ms, and the communication data at the channel B is transmitted every 289 ms. Therefore, the transmission collision of the communication data occurs every 3.179 s which denotes “3179” (ms) corresponding to the least common multiple of “187” (ms) and “289” (ms).

The frequency of the transmission collision of the communication data can be reduced by selecting the transmission cycle of a prime number set as high as possible. Tough there is a case that the transmission cycle is set to a number including a decimal fraction, the transmission collision of the communication data occurs in the same manner.

Tough two transmission cycles at the channels A and B can be set, it is preferable that one transmission cycle can be selected from three or more transmission cycles and be set. Also, it is preferable that two transmission cycles other than 187 ms and 289 ms be set.

The transmitter control section 120 is made of a central processing unit (CPU) or the like and denotes a functional section for controlling the remote controller 100 as a unified body. The transmitter control section 120 comprises a communication data generating section 122 and a transmission timing control section 124. The communication data generating section 122 generates communication data including both the operational data outputted from the operating section 112 and the identification data (ID) 142 stored in the storage section 140 and outputs the communication data to the transmitting section 130.

FIG. 4 is a view showing a data format of the communication data. The communication data comprises synchronization bits of 4 bits for the communication synchronization, ID bits of 2 bits indicating a value of the ID 142, running instruction bits of 4 bits instructing 16 levels of speeds (corresponding to acceleration opening) including forward/backward, steering instruction bits of 4 bits indicating 16 levels of steering angles in the right and left directions and inspection bits of 4 bits for error detection and error correction. The running instruction bits and the steering instruction bits indicate the operational data.

The transmission timing control section 124 latches the operational data outputted from the operating section 112 in timing corresponding to the channel set in the channel setting section 118. Thereafter, the section 124 compares the latched operational data and last operational data 152 stored in the temporarily storage section 150 and judges whether or not the latched operational data is identical with the last operational data 152. When those are judged to be identical with each other, the transmission of the communication data in that timing is stopped. Therefore, no transmission instructing signal is output. In contrast, when those are judged not to be identical with each other, a transmission instructing signal is outputted from the transmission timing control section 124 to the transmitting section 130 to transmit the communication data in that timing.

That is, it is judged whether or not a change (displacement) occurs in the amount of the operation of the control stick 1-12 or 2-12 performed by the user. When no change occurs in the amount of the operation due to the fixed operation of the user, the operational data output from the operating section 112 is identical with the last operational data 152.

After the judgment of the identity, the transmission timing control section 124 writes the operational data output from the operating section 112 in the temporarily storage section 150 as the last operational data 152 to renew the data 152 of the temporarily storage section 150.

The transmitting section 130 comprises a digital-to-analog converter, an oscillator and an antenna (not shown). When the transmission instructing signal output from the transmission timing control section 124 is inputted to the transmitting section 130, the transmitting section 130 modulates the communication data output from the communication data generating section 122 according to the amplitude-shift keying and transmits the modulated communication data.

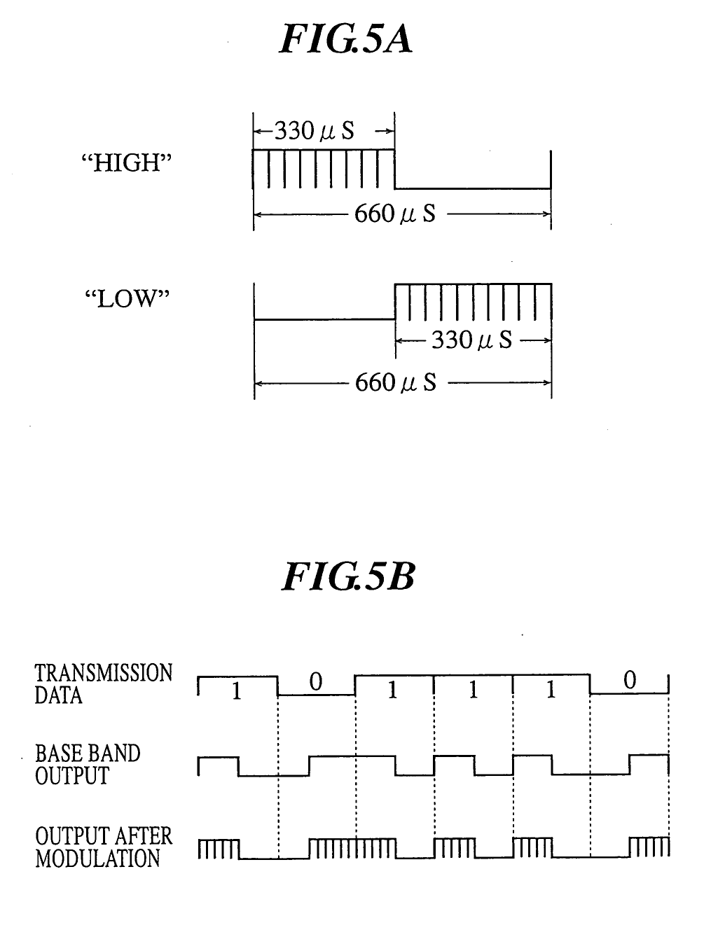

FIG. 5A is a view showing the definition of “high” and “low” in the amplitude-shift keying of the transmitting section 130, and FIG. 5B is a view showing an example of the modulated output.

The transmitting section 130 performs the data transmission at the communication frequency of 27 MHz. Therefore, a time period required to transmit the 18-bit communication data shown in FIG. 4 equals 11.88 ms (=660 μs×18 bits). Because the time required to transmit the communication data is sufficiently short as compared with the transmission cycles at the channels A and B, the frequency of the superposition of a part of the communication data at the channel A on a part of other communication data at the channel B can be reduced in the data transmission.

The storage section 140 is made of a nonvolatile memory such as a read only memory (ROM) or the like and stores the ID142 and various programs executed to enable the transmitter control section 120 to function. The ID 142 indicating a value peculiar to the corresponding remote-controlled toy is stored in advance. For example, the ID 142 of the remote-controlled toy 1 differs from that of the remote-controlled toy 2. The temporarily storage section 150 is made of a random access memory (RAM) or the like and stores the last operational data 152.

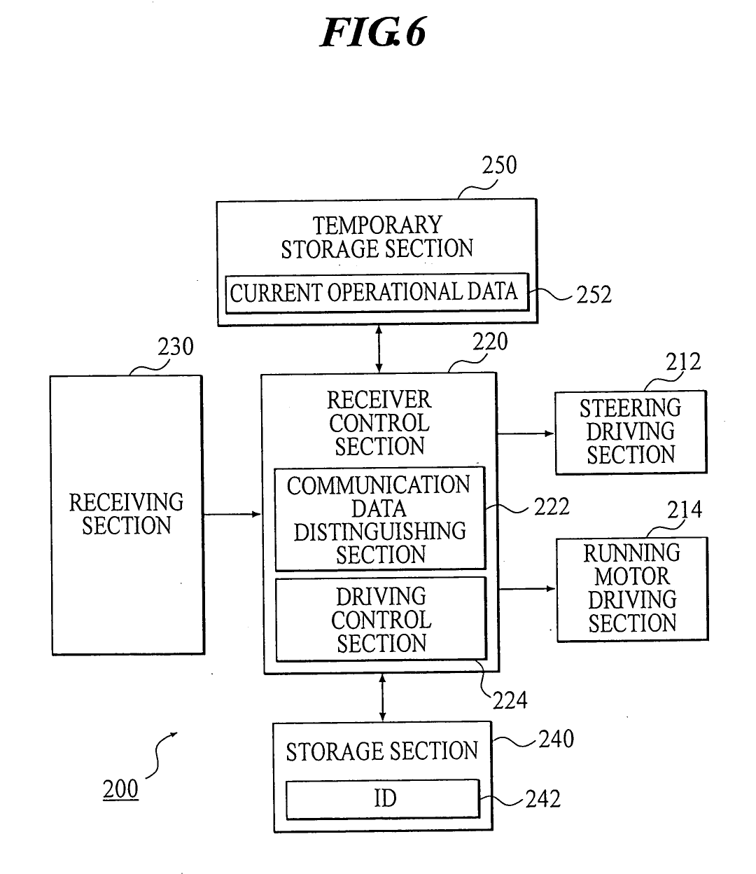

FIG. 6 is a functional block diagram of the running toys 1-2 and 2-2 (hereinafter, named a running toy 200 comprehensively). The running toy 200 comprises a receiver control section 220, a receiving section 230, a storage section 240, a temporarily storage section 250, a steering driving section 212 and a running motor driving section 214.

The receiving section 230 comprises an antenna, an amplifier, a wave detector and an A/D converter (not shown). The receiving section 230 denotes a functional section for embodying the wireless communication with the transmitting section 130 of the remote controller 100. Also, the receiving section 230 outputs the received communication data to the receiver control section 220.

The receiver control section 220 is made of a CPU or the like and denotes a functional section for controlling the running toy 200 as a unified body. The receiver control section 220 comprises a communication data distinguishing section 222 and a driving control section 224. The communication data distinguishing section 222 compares the ID included in the communication data and the ID 242 stored in the storage section 240 and judges whether or not the communication data outputted from the receiving section 230 denotes communication data sent for this running toy 200 (hereinafter, named communication data for this receiver). In detail, when the ID of the communication data output from the receiving section 230 is identical with the ID 242 stored in the storage section 240, the communication data distinguishing section 222 judges that the ID of the received communication data denotes the communication data for this receiver. Thereafter, when the communication data distinguishing section 222 judges to be the communication data for this receiver, the operational data included in the communication data is written and stored in the temporarily storage section 252 as current operational data 252 to renew the data 252.

The driving control section 224 controls the driving of both the steering driving section 212 and the running motor driving section 214 according to the current operational data 252 stored in the temporarily storage section 250. In detail, the steering driving section 212 drives a motor used to change an angle of rotated front wheels of the running toy 200. The running motor driving section 214 drives a motor used to rotate rear wheels (driving wheels) of the running toy 200 forward or backward. The driving control section 224 outputs control signals to control both an amount (engine speed) of driving and a rotational direction in each of the motors driven by the steering driving section 212 and the running motor driving section 214.

Also, the driving control section 224 controls the motor according to the current operational data 252 regardless of the transmission timing of the communication data. In detail, regardless of the reception of the communication data for this receiver, the driving control section 224 always controls the driving of the motor according to the current operational data 252 of the temporarily storage section 250. Therefore, when the communication data for this receiver is not received, the driving control section 224 continues controlling the driving of the motor according to the current operational data 252 stored.

The storage section 240 is made of a nonvolatile memory such as a ROM or the like and stores the ID242 and various programs executed to enable the receiver control section 220 to function. The ID 242 is the same as the ID 142 stored in the storage section 140 of the corresponding remote controller 100, and the ID 242 indicating a value peculiar to the corresponding remote-controlled toy is stored in advance. The temporarily storage section 250 is made of a RAM or the like and stores the operational data of the communication data, which is judged by the communication data distinguishing section 222 to be the communication data for this receiver, as the current operational data 252.

Next, the operation of the remote-controlled toy in the transmission and reception of the communication data will be explained.

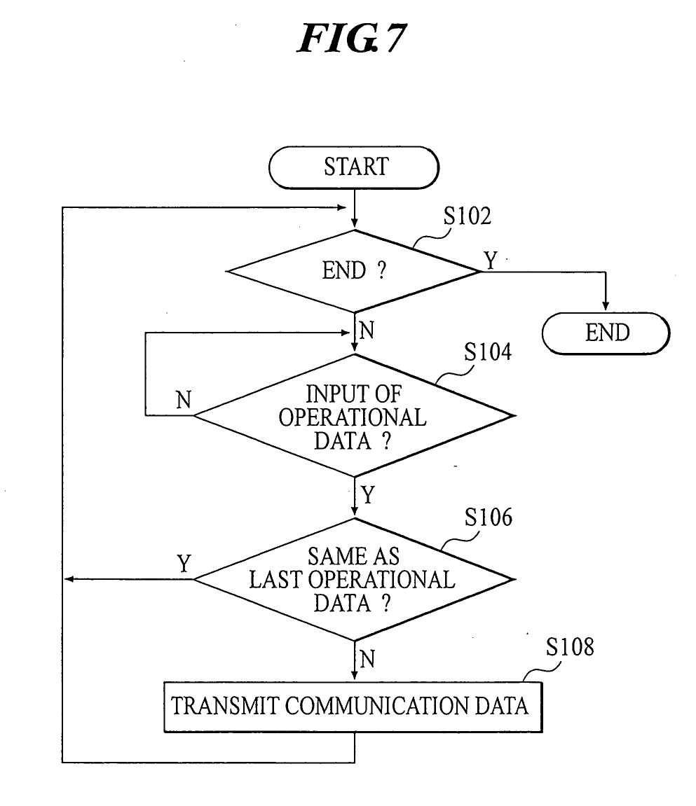

FIG. 7 is a flow chart schematically showing the operation of the remote controller 100 in the transmission of the communication data. The processing is repeatedly performed until a completing operation like the cutting off of power source is performed (Step S102). Initially, when the channel setting section 118 of the remote controller 100 sets the transmission cycle, the transmitter control section 120 waits for the operational data inputted to the inputting section 110 (Step S104).

When the operational data is inputted to the inputting section 110 (Step S104; YES), the transmitter control section 120 judges whether or not the inputted operational data is identical with the last operational data 152 stored in the temporarily storage section 150 (Step S106). In other words, the transmitter control section 120 judges whether or not the operation inputted by the user is changed.

When the transmitter control section 120 judges that the inputted operational data is identical with the last operational data 152 (Step S106; YES), or when the section 120 judges that there is no change in the operation inputted by the user, the section 120 makes the procedure proceed to Step S102. In contrast, when the section 120 judges that the inputted operational data is not identical with the last operational data 152 (Step S106; NO), or when the section 120 judges that there is a change in the operation inputted by the user, the communication data is transmitted (Step S108). In short, when the transmission timing control section 124 outputs the transmission instructing signal to the transmitting section 130, the communication data including both the operational data inputted in Step S104 and the ID 142 stored in the storage section 140 and generated in the communication data generating section 122 is transmitted from the transmitting section 130.

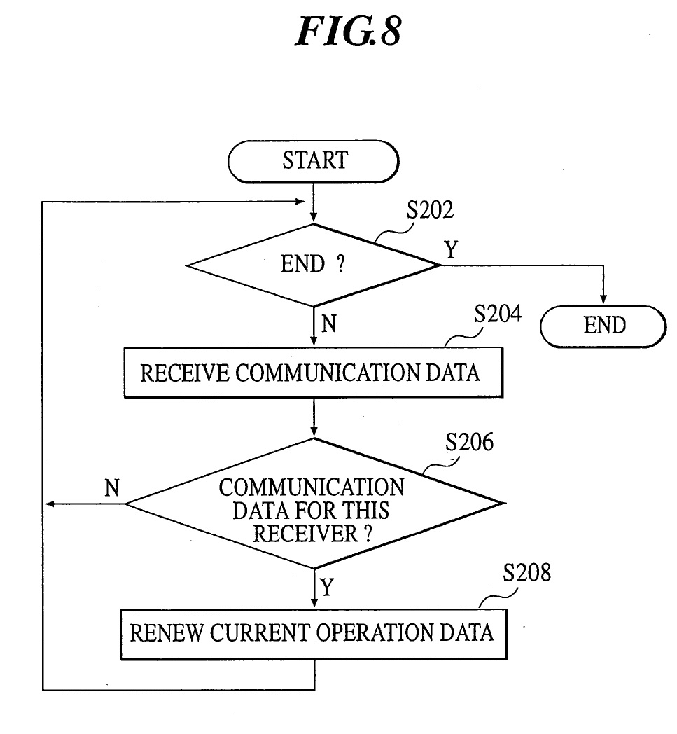

FIG. 8 is a flow chart schematically showing the operation of the running toy 200 in the reception of the communication data. The processing is repeatedly performed until a play completing operation like the cutting off of power source is performed (Step S202). Initially, the receiving section 230 of the running toy 200 waits for the communication data (Step S204). When the receiving section 230 receives the communication data, the communication data distinguishing section 222 refers to the ID 242 stored in the storage section 240 and judges whether or not the received communication data denotes the communication data for this receiver (Step S206).

When the communication data distinguishing section 222 judges that the received communication data denotes the communication data for this receiver, the section 222 stores the operational data included in the communication data for this receiver as the current operational data 252 in the temporarily storage section 250 to renew the current operational data 252 (Step S208). Here, the driving control section 224 controls the driving of both the steering driving section 212 and the running motor driving section 214 according to the current operational data 252 stored in the temporarily storage section 250 regardless of the reception of the communication data.

As described above, the remote controller 100 according to the first embodiment transmits the communication data only when the operational data is changed. Therefore, it is not required to always transmit the communication data every time period corresponding to the transmission cycle. As a result, when the users play with a plurality of remote-controlled toys, the occurrence of the collision of the communication data can be reduced.

Here, in the first embodiment, when the operational data output from the operating section 112 is inputted to the communication data generating section 122, the communication data is always generated. However, it is preferable that the communication data be generated only when it is judged that the operational data received from the operating section 112 is not identical with the last operational data 152.

Also, when it is judged that the operational data received from the operating section 112 is identical with the last operational data 152, the transmission timing control section 124 does not output any transmission instructing signal to the transmitting section 130. However, a following modification is preferable. When it is judged at a current time to be identical with each other on condition that it was judged at a preceding time just before the current time not to be identical with each other, the outputting of the transmission instructing signal is stopped when a prescribed time period elapses after the preceding time. Specifically, when the received operational data is not identical with the last operational data 152 at a preceding time just before a current time, the transmission instructing signal is output at the preceding time. However, even though it is judged at the current time to be identical with each other, the sudden stop of the outputting of the transmission instructing signal (hereinafter, named “instantaneous stop”) at the current time is not adopted, but the outputting of the transmission instructing signal is stopped when a prescribed time period elapses after the preceding time (hereinafter, named “stop delay”). For example, when a time period equal to twice of the transmission cycle is set as the prescribed time period, the communication data is transmitted twice after the preceding time.

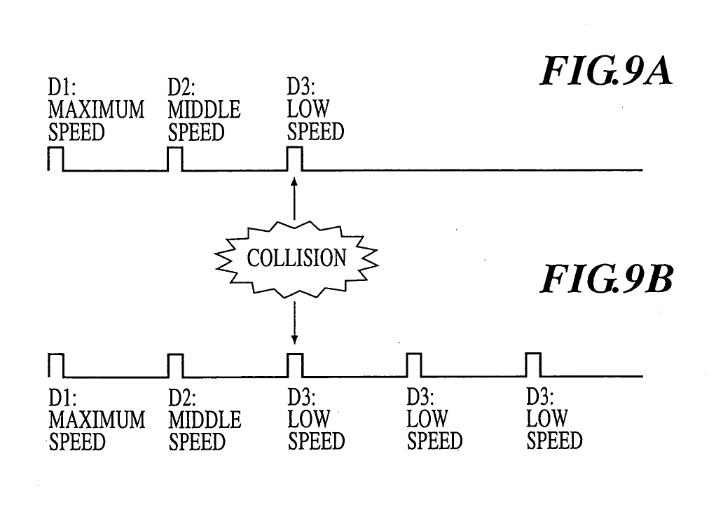

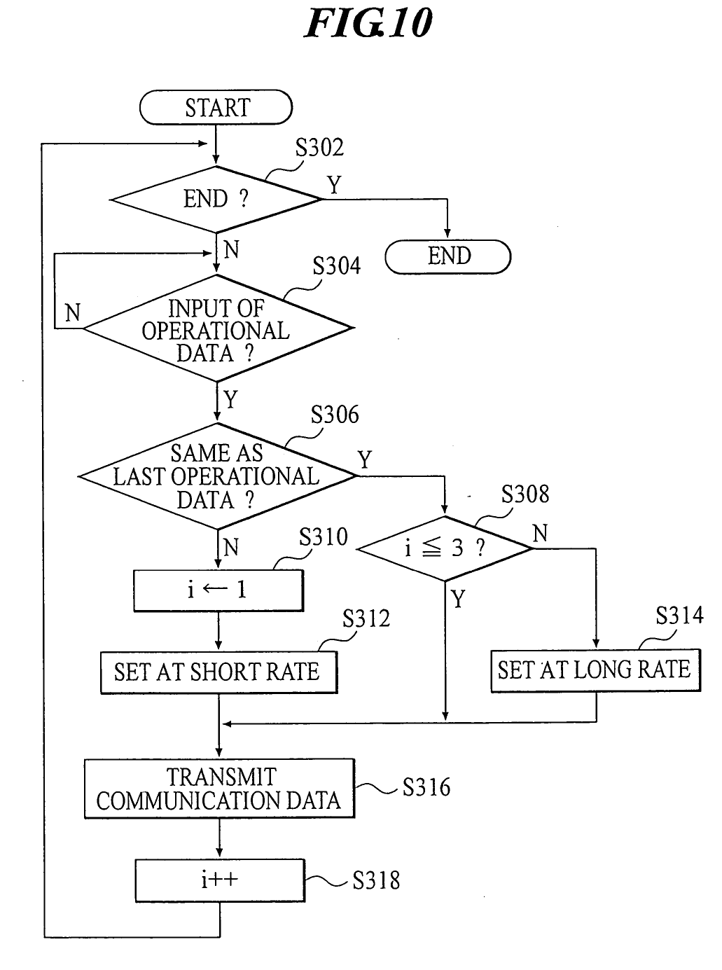

This transmission stopping will be explained in detail with reference to FIGS. 9A and 9B. FIG. 9A is a view showing an example of the spontaneous stop, and FIG. 9B is a view showing an example of the stop delay. A lateral axis indicates the time axis. In FIG. 9A, contents of the pieces of operational data of the pieces of communication data D1 to D3 are changed in order of “maximum speed”, “middle speed” and “low speed”. Thereafter, because the operational instruction indicating “low speed” is not changed, the transmission of the communication data is stopped. However, assuming that the collision in the data transmission occurs at the transmission time of the communication data D3 including the operational data of “low speed”, the communication data D3 of “low speed” cannot be received in the running toy 200. Therefore, the running toy 200 continues running at the “middle speed”.

In contrast, in case of the stop delay, as shown in FIG. 9B, because the communication data including the operational data of “low speed” is repeatedly transmitted, the running toy 200 reliably runs at the “low speed”.

Second Embodiment:

Next, the second embodiment will be explained.

A main difference between the second embodiment and the first embodiment exists in the transmission timing control unit 124, and the transmission cycles set in the channels A and B differ from those in the first embodiment. Therefore, to simply explain the second embodiment, constituent elements including the transmission timing control unit 124 are indicated by the same reference numerals as those in the first embodiment, operations different from those in the first embodiment are explained, and the same operations as those in the first embodiment are omitted.

Channels in the second embodiment are initially explained. A “long rate” corresponding to a long transmission cycle (transmission interval) and a “short rate” corresponding to a short transmission cycle are preset for each of the channels A and B. Specifically, in the channel A, the long rate of 487 ms and the short rate of 95 ms are set. In the channel B, the long rate of 511 ms and the short rate of 107 ms are set.

In the same manner as in the first embodiment, the channel setting section 118 outputs a signal indicating the channel selected and set by the user to the transmitter control section 120.

The transmission timing control section 124 compares the operational data inputted from the operating section 112 with the last operational data 152 stored in the temporarily storage section 150. When the section 124 judges not to be identical with each other, the transmission timing control section 124 makes the transmitting section 130 transmit the operational data received from the operating section 112 at the short rate of the channel set in the channel setting section 118. In contrast, when the section 124 judges to be identical with each other, the transmission timing control section 124 makes the transmitting section 130 transmit the operational data received from the operating section 112 at the long rate of the set channel. Here, even in case of the judgment to be identical, the last operational data 152 is transmitted twice to substantially transmit the operational data received from the operating section 112 three times. When the section 124 judges in the middle of the three-times-transmission not to be identical with each other, the transmission of the last operational data 152 is stopped, and the transmission timing control section 124 controls the transmitting section 130 to transmit updated operational data at the short rate.

The second embodiment will be explained in detail with reference to FIG. 10.

FIG. 10 is a flow chart schematically showing the operation in the transmission of the communication data of the remote controller 100 according to the second embodiment. The processing is repeatedly performed until a completing operation like the cutting off of power source is performed (Step S302). Initially, when the channel setting section 118 of the remote controller 100 sets the channel, the transmitter control section 120 waits for the operational data inputted to the inputting section 110 (Step S304).

When the operational data is inputted to the inputting section 110 (Step S304; YES), the transmitter control section 120 judges whether or not the inputted operational data is identical with the last operational data 152 stored in the temporarily storage section 150 (Step S306). In other words, the transmitter control section 120 judges whether or not the operation inputted by the user is changed.

When the transmitter control section 120 judges that the inputted operational data is identical with the last operational data 152 (Step S306; YES), or when the section 120 judges that there is no change in the operation inputted by the user, the transmitter control section 120 judges whether or not the value of a variable i is not more than “3” (Step S308). Here, it is preferred that the variable i is stored in the temporarily storage section 150, or the transmission timing control section 124 has a register for storing the variable i and the variable i is stored in the register.

In contrast, when the transmitter control section 120 judges that the inputted operational data is not identical with the last operational data 152 (Step S306; NO), or when the section 120 judges that there is a change in the operation inputted by the user, the variable i is set to “1”, and the transmission cycle is set to the short rate of the channel set in the channel setting section 118 (Step S312)

In Step S308, the transmitter control section 120 judges that the value of the variable i is more than “3” (Step S308; NO), the transmission timing control section 124 sets the transmission cycle to the long rate of the channel set in the channel setting section 118 (Step S314).

After the processing of Step S312 or S314, or when the transmitter control section 120 judges that the value of the variable i is not more than “3” (Step S308; YES), the transmission timing control section 124 controls the transmitting section 130 to transmit the communication data in the transmission cycle currently set (Step S316). Thereafter, the variable i is incremented (Step S318), and the procedure returns to Step S302.

In other words, when the operation inputted by the user is changed, the communication data is transmitted at the short rate of the channel set in the channel setting section 118. In contrast, even when the operation inputted by the user is not changed, the communication data is transmitted at least three times at the short rate.

As described above, in the second embodiment, when the operation (the quantity of operation) inputted by the user is changed, the remote control of the running toy at superior responsive performance can be embodied by the communication at the short rate. In contrast, when the operation inputted by the user is not changed, the collision in the data transmission can be avoided within the range of possibility by the communication at the long rate. In short, the remote-controlled toy satisfying two contrary conditions of both the length of the transmission cycle and the responsive performance can be embodied.

Here, when the operation inputted by the user is not changed, because of the communication at the long rate, as compared with the first embodiment in which no operational data is transmitted, there is a probability that the collision in the data transmission occurs. However, the running toy can be more reliably controlled when the inputted operation is not changed.

Also, when the operation inputted by the user is not changed, the short rate is not immediately changed to the long rate, but the transmission of the operational data at the short rate is performed three times. Therefore, even when the inputted operation is not changed, the final operational data can be more reliably transmitted to the running toy, and the remote control for the running toy can be performed more reliably.

In the second embodiment, the transmission of the same operational data at the short rate is performed three times. However, it is preferable that the transmission of the same operational data at the short rate be performed only twice or four times or more. Also, it is preferable that the number of transmission operations of the same operational data be not set but the transmission of the same operational data at the short rate be performed for a predetermined time period. Also, it is preferable that two channels A and B be not used but three channels or more be used.

Also, two transmission cycles of the short rate and the long rate are set for each channel. However, it is preferable that three transmission cycles or more be set for each channel. For example, it is preferable that three transmission cycles of the short rate (95 ms), the long rate (487 ms) and a super long rate (2388 ms) be set for each channel. In this case, when the operational data is not changed, the short rate is changed to the long rate in the same manner as in the second embodiment. When the operational data not changed is continued for a prescribed time period, the long rate is changed to the super long rate to change the transmission cycle step by step.

The entire disclosure of Japanese Patent Application No. Tokugan 2002-301720 filed on Oct. 16, 2002 including specification, claims, drawings and summary are incorporated herein by reference in its entirety.

What is claimed is:

1. A remote-controlled toy comprising:
a transmitter having an operating section, for transmitting communication data including both identification data and operational data received from the operating section; and
a receiver for receiving the communication data transmitted from the transmitter, setting the communication data as communication data for this receiver when the identification data included in the received communication data is identical with identification data stored in a storage section in advance, and performing a control operation based on the operational data of the communication data for this receiver,
the transmitter further comprising:
a setting section for setting a transmission cycle of the communication data;
a judging section for judging whether or not the operational data inputted to the operating section is changed; and
a transmission control section for transmitting no communication data when the judging section judges that the operational data inputted to the operating section is not changed, and transmitting the communication data at the transmission cycle set by the setting section when the judging section judges that the operational data inputted to the operating section is changed, and
the receiver continuing performing the current control operation until new communication data for this receiver is received.

2. The remote-controlled toy as claimed in claim 1; wherein the transmission control section stops transmitting the communication data, when the judging section judges that the operational data inputted to the operating section is not changed, after the elapsing of a prescribed time period from a last judgment for last operational data inputted to the operating section to be changed or after the transmission of the communication data prescribed number times from the last judgment for the last operational data inputted to the operating section to be changed.

3. The remote-controlled toy as claimed in claim 1; wherein the setting section has a switch for selecting a transmission cycle from a plurality of transmission cycles and sets the transmission cycle selected by the switch as the transmission cycle of the communication data.

4. The remote-controlled toy as claimed in claim 2; wherein the setting section has a switch for selecting a transmission cycle from a plurality of transmission cycles and sets the transmission cycle selected by the switch as the transmission cycle of the communication data.

5. A remote-controlled toy comprising:
a transmitter having an operating section, for transmitting communication data including both identification data and operational data received from the operating section; and
a receiver for receiving the communication data transmitted from the transmitter, setting the communication data as communication data for this receiver when the identification data included in the received communication data is identical with identification data stored in a storage section in advance, and performing a control operation based on the operational data of the communication data for this receiver,
the transmitter further comprising:
a selecting section for selecting a channel from a plurality of channels, at least two transmission cycles of a long cycle and a short cycle being preset for each channel;
a judging section for judging whether or not the operational data inputted to the operating section is changed; and
a transmission control section for changing the transmission cycles, which are set in the channel selected by the selecting section, according to a judgment result of the judging section, and controlling the communication data to be transmitted in the changed transmission cycle, and
the receiver continuing performing the current control operation until new communication data for this receiver is received.

6. The remote-controlled toy as claimed in claim 5; wherein the transmission control section changes the transmission cycle to the long cycle, when the judging section judges that the operational data inputted to the operating section is not changed, and changes the transmission cycle to the short cycle when the judging section judges that the operational data inputted to the operating section is changed.

7. The remote-controlled toy as claimed in claim 5; wherein the transmission control section changes the transmission cycle to the short cycle, when the judging section judges that the operational data inputted to the operating section is changed, and changes the transmission cycle to the long cycle, when the judging section judges for the operational data inputted to the operating section not to be changed after a last judgment to be changed, after the elapsing of a prescribed time period from the last judgment or after the transmission of the communication data prescribed number times from the last judgment.

8. The remote-controlled toy as claimed in claim 7; wherein the transmission control section changes the transmission cycle to the short cycle, when the judging section judges that the operational data inputted to the operating section is changed, and changes the transmission cycle to the long cycle, when the judging section judges for the operational data inputted to the operating section not to be changed after a last judgment to be changed, after the elapsing of a prescribed time period from the last judgment or after the transmission of the communication data prescribed number times from the last judgment.

9. The remote-controlled toy as claimed in claim 1; wherein a communication frequency in the communication between the transmitter and the receiver is constant.

10. The remote-controlled toy as claimed in claim 5; wherein a communication frequency in the communication between the transmitter and the receiver is constant.
